(19) United States
(12) Patent Application Publication
(10) Pub. No.: US 2024/0319395 A1
(43) Pub. Date: Sep. 26, 2024

(54) EXTRAPOLATION OF SEISMIC DATA TO REDUCE PROCESSING EDGE ARTIFACTS

(71) Applicant: SAUDI ARABIAN OIL COMPANY, Dhahran (SA)

(72) Inventors: Jewoo Yoo, Delft (NL); Paul Zwartjes, Wassenaar (NL); Robertus F. Hegge, Rijswijk (NL); Roald Van Borselen, Voorschoten (NL)

(73) Assignee: ARAMCO OVERSEAS COMPANY B.V., The Hague (NL)

(21) Appl. No.: 18/189,906

(22) Filed: Mar. 24, 2023

(51) Int. Cl. G01V 1/36; E21B 44/00; E21B 49/00; G01V 1/28; G01V 1/30; G06N 20/00

(52) U.S. Cl. CPC G01V 1/362; E21B 44/00; E21B 49/00; G01V 1/282; G01V 1/302; G06N 20/00; E21B 7/04; E21B 2200/22; G01V 2210/614

(57) ABSTRACT

Examples of methods and systems are disclosed. The methods may include obtaining, using a seismic processor, a training seismic dataset, comprising an input seismic dataset with a first extent and an output seismic dataset with a second extent, wherein the second extent is greater than the first extent. The methods may also include training, using the seismic processor and the training seismic dataset, a machine-learning (ML) network to predict the output seismic dataset, at least in part, from the input seismic dataset.

### BACKGROUND

In the oil and gas industry, seismic surveys are conducted over subsurface regions of interest during the search for, and characterization of, hydrocarbon reservoirs. In seismic surveys, a seismic source generates seismic waves that propagate through the subterranean region of interest and are detected by seismic receivers. The seismic receivers detect and store a time-series of samples of earth motion caused by the seismic waves. The collection of time-series of samples recorded at many receiver locations generated by a seismic source at many source locations constitutes a seismic dataset.

To determine the earth structure, including the presence of hydrocarbons, the seismic dataset may be processed. Processing a seismic dataset includes a sequence of steps designed to correct for a number of issues, such as near-surface effects, noise, irregularities in the seismic survey geometry, etc. Another step in processing a seismic dataset may be the mitigation of artifacts introduced by some data processing techniques. A properly processed seismic dataset may aid in decisions as to if and where to drill for hydrocarbons.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a method. The method includes obtaining, using a seismic processor, a training seismic dataset, including an input seismic dataset with a first extent and an output seismic dataset with a second extent, wherein the second extent is greater than the first extent. The method also includes training, using the seismic processor and the training seismic dataset, a machine-learning (ML) network to predict the output seismic dataset, at least in part, from the input seismic dataset.

In general, in one aspect, embodiments disclosed herein relate to a system. The system includes a seismic acquisition system configured to record an observed seismic dataset pertaining to a subsurface region of interest. The system also includes a seismic processor, configured to obtain a training seismic dataset, comprising an input seismic dataset with a first extent and an output seismic dataset with a second extent, wherein the second extent is greater than the first extent. The seismic processor is also configured to train, using the training seismic dataset, a machine-learning network to predict the output seismic dataset, at least in part, from the input seismic dataset. The seismic processor is further configured to obtain an observed seismic dataset pertaining to a subsurface region of interest with a third extent. The seismic processor is still further configured to predict, using the trained machine learning network, an extended seismic dataset with a fourth extent, at least in part, from the observed seismic dataset, wherein the fourth extent is greater than the third extent.

It is intended that the subject matter of any of the embodiments described herein may be combined with other embodiments described separately, except where otherwise contradictory.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIG. 1 depicts a seismic acquisition system of a subsurface region of interest, according to one or more embodiments of the present disclosure.

FIG. 2 shows examples of seismic data produced by a seismic acquisition system in accordance with one or more embodiments.

FIG. 3 depicts a drilling system in accordance with one or more embodiments.

FIG. 4 illustrates an example of filtering seismic data to remove multiples according to one or more embodiments.

FIG. 5 shows examples of tapering and extrapolating seismic data, in accordance with one or more embodiments.

FIG. 6 shows a flowchart in accordance with one or more embodiments.

FIG. 7 illustrates an example of training data according to one or more embodiments.

FIG. 8 shows a flowchart in accordance with one or more embodiments.

FIG. 9 depicts a neural network in accordance with one or more embodiments.

FIG. 10 depicts a convolutional neural network in accordance with one or more embodiments.

FIG. 11 illustrates an example of extrapolating simulated seismic data, according to one or more embodiments.

FIG. 12 shows an example of transformed extended seismic data, according to one or more embodiments.

FIG. 13 illustrates an example of filtering extended seismic data, in accordance with one or more embodiments.

FIG. 14 shows an example of extrapolating acquired seismic data, in accordance with one or more embodiments.

FIG. 15 illustrates an example of extrapolating acquired seismic data, in accordance with one or more embodiments.

FIG. 16 shows an example of filtering extended and non-extended seismic data, in accordance with one or more embodiments.

FIG. 17 illustrates an example of transformed filtered extended and non-extended seismic data, according to one or more embodiments.

FIG. 18 depicts a system in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

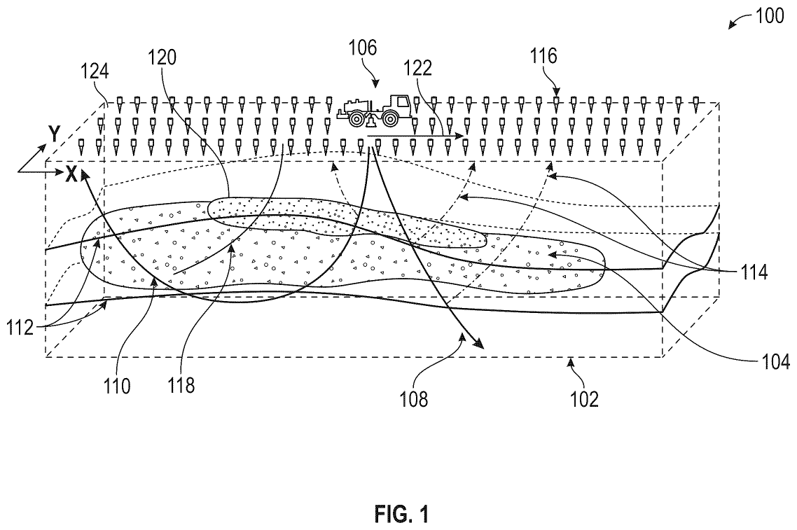

In the following description of FIGS. 1-18, any component described regarding a figure, in various embodiments disclosed herein, may be equivalent to one or more like-named components described with regard to any other figure. For brevity, descriptions of these components will not be repeated regarding each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

It is to be understood that the singular forms “a,” “an,” and “the” include plural referents unless the context clearly dictates otherwise. Thus, for example, reference to “a seismic signal” includes reference to one or more of such seismic signals.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the steps shown in the flowcharts may be omitted, repeated, and/or performed in a different order than the order shown. Accordingly, the scope disclosed herein should not be considered limited to the specific arrangement of steps shown in the flowcharts.

In general, disclosed embodiments include systems and methods to extrapolate seismic dataset beyond the spatial or temporal range over which they were recorded to minimize edge artifacts introduced by applying seismic processing techniques to finite-aperture seismic datasets. In particular, in some embodiments extrapolation of the seismic data is performed with a machine-learning (ML) network, trained with synthetic datasets. The synthetic seismic datasets are directly generated as a composition of geometric shapes. Further, the synthetic datasets, when used to train a ML network, develop a ML network that is capable of generalizing to new, unseen, and real seismic datasets.

It is noted that while the methods described herein will be described in the context of a seismic dataset in two dimensions, these methods are not limited to these seismic datasets. In general, embodiments disclosed herein can be applied to any pre-stack and post-stack seismic data. For example, embodiments disclosed herein can be applied to a collection of shot gathers before or after migration and to stacked seismic datasets that are obtained by the application of move-out corrections. In other words, one with ordinary skill in the art will appreciate that the methods disclosed herein are applicable to seismic datasets that have undergone any number of pre-processing (or processing) steps commonly employed in the art.

In seismic data processing, mathematical operations may be applied to seismic data organized in space and time dimensions. One of the common mathematical operations applied to such seismic data is filtering using convolution operators. Another type of operation involves domain transformation, such as, for example, transforming data in a time-space domain to a frequency-wavenumber domain. The presence of non-zero data near the edges of the data domain may result the introduction of “artifacts”, data with no physical meaning, when applying mathematical operations such as those mentioned above.

Tapering the seismic data to zero near the edges of the data domain may be effective in reducing edge effects, but it may also result in significant loss of information. Other techniques may be implemented to reduce edge effects while preserving the seismic data. One such technique involves simulating the artifacts and subtracting them from the processed data. However, modelling assumptions for the artifacts may be difficult to establish. Another technique may include extrapolating the seismic data beyond the edges with a physical model of the medium of propagation, before seismic processing. Edge effect artifacts may be present but affect only the extended data, which after seismic processing may be tapered or removed without incurring in loss of seismic data. Once again, modelling hypothesis for the physical model may be difficult to establish, and numerical simulations of wave propagation in several dimensions may be computational expensive. A method to reduce edge effect artifacts with minimal modelling assumptions and of low computational cost mat assist in improving the accuracy of seismic data used to generate seismic images.

Because a seismic dataset contains spatial and lithology information about a subterranean region of interest, the seismic dataset may be used to construct a seismic image of the subterranean region of interest. The resulting seismic image may then be used for further seismic data interpretation, such as in updating the spatial extension of a hydrocarbon reservoir. The seismic data interpretation may be performed using a seismic interpretation workstation, that may include a computer processor equipped with suitable software, display devices such as screens, projectors, or monitors, and mechanisms for the operator to interact with the seismic images and data, such as computer mice, wands, and touch sensitive screens. Thus, the disclosed methods are integrated into the established practical applications for improving seismic images and searching for an extraction of hydrocarbons from subsurface hydrocarbon reservoirs. The disclosed methods represent an improvement over existing methods for at least the reasons of lower cost and increased efficacy.

FIG. 1 shows a seismic acquisition system (100) that may be used to acquire a seismic dataset pertaining to a subsurface region of interest (102), in accordance with one or more embodiments. In some cases, the subsurface region of interest (102) may lie beneath a lake, sea, or ocean. In other cases, the subsurface region of interest (102) may lie beneath an area of dry land. The subsurface region of interest (102) may contain a hydrocarbon deposit (120) that may form part of a hydrocarbon reservoir (104). The seismic acquisition system (100) may utilize a seismic source (106) that generates radiated seismic waves (108). The type of seismic source (106) may depend on the environment in which it is used, for example on land the seismic source (106) may be a vibroseis truck or an explosive charge, but in water the seismic source (106) may be an airgun. The radiated seismic waves (108) may return to the surface as refracted seismic waves (110) or reflected seismic waves (114).

Refracted seismic waves (110) and reflected seismic waves (114) may occur, for example, due to geological discontinuities (112) that may be also known as “seismic reflectors”. The geological discontinuities (112) may be, for example, planes or surfaces that mark changes in physical or chemical characteristics in a geological structure. The geological discontinuities (112) may be also boundaries between faults, fractures, or groups of fractures within a rock. The geological discontinuities (112) may delineate a hydrocarbon reservoir (104).

At the surface, refracted seismic waves (110) and reflected seismic waves (114) may be detected by seismic receivers (116). Radiated seismic waves (108) that propagate from the seismic source (106) directly to the seismic receivers (116), known as direct seismic waves (122), may also be detected by the seismic receivers (116).

In some embodiments, a seismic source (106) may be positioned at a location denoted (xₛ, yₛ) where x and y represent orthogonal axes on the earth's surface above the subsurface region of interest (102). The seismic receivers (116) may be positioned at a plurality of seismic receiver locations denoted (xᵣ, yᵣ), with the distance between each receiver and the source being termed “the source-receiver offset”, or simply “the offset”. Thus, the direct seismic waves (122), refracted seismic waves (110), and reflected seismic waves (114) generated by a single activation of the seismic source (106) may be represented in the axes (xₛ, yₛ, xᵣ, yᵣ, t). The t-axis delimits the time sample at which the seismic acquisition system (100) activated the seismic source (106) and acquired the seismic data by the seismic receivers (116).

Once acquired, seismic data may undergo a myriad of pre-processing steps. These pre-processing steps may include but are not limited to: reducing signal noise; applying move-out corrections; organizing or resampling the traces according to a regular spatial pattern (i.e., regularization); and data visualization. One with ordinary skill in the art will recognize that many pre-processing (or processing) steps exist for dealing with a seismic dataset. As such, one with ordinary skill in the art will appreciate that not all pre-processing (or processing) steps can be enumerated herein and that zero or more pre-processing (or processing) steps may be applied with the methods disclosed herein without imposing a limitation on the instant disclosure.

In some instances, seismic processing may reduce five-dimensional seismic data produced by a seismic acquisition system (100) to three-dimensional (x,y,t) seismic data by, for example, correcting the recorded time for the time of travel from the seismic source (106) to the seismic receiver (116) and summing (“stacking”) samples over two horizontal space dimensions. Stacking of samples over a predetermined time interval may be performed as desired, for example, to reduce noise and improve the quality of the signals.

Seismic data may also refer to data acquired over different time intervals, such as, for example, in cases where seismic surveys are repeated to obtain time-lapse data. Seismic data may also be pre-processed data, e.g., arranged as a “common shot gather” (CSG) domain, in which waveforms are acquired by different receivers but a single source location. Further, seismic data may also refer to datasets generated via numerical simulations by modeling wave propagation phenomena in the subsurface region of interest (102). The noted seismic data is not intended to be limiting, and any other suitable seismic data is intended to fall within the scope of the present disclosure. Seismic data to be processed with the present disclosed methods, whether acquired or simulated, is referred herein to as an “observed seismic dataset”.

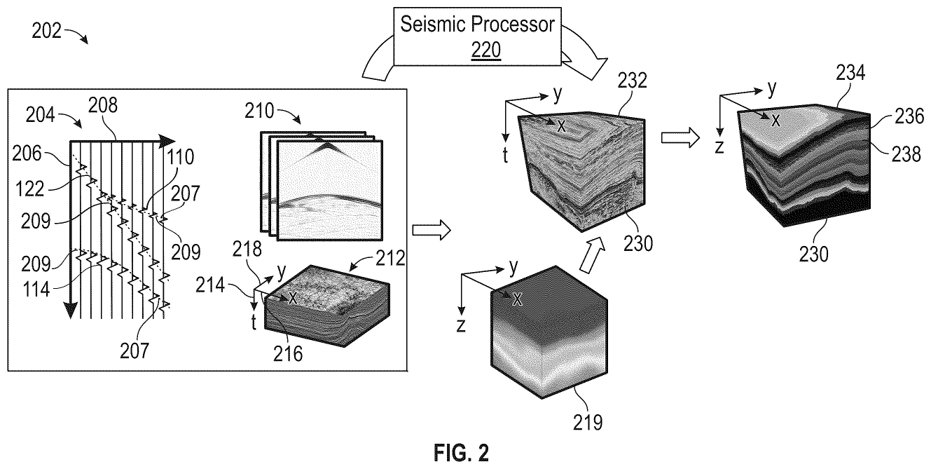

FIG. 2 shows examples of observed seismic datasets (202) produced by a seismic acquisition system (100) in accordance with one or more embodiments. An example of a CSG (204) illustrates the detection of direct seismic waves (122), refracted seismic waves (110), and reflected seismic waves (114) generated by a single activation of the seismic source (106) and recorded by a several colinear seismic receivers (116). Each seismic receiver (116) may record a time-series representing the amplitude of ground-motion at a sequence of discrete times. This time-series may be denoted or otherwise referred to as a “waveform”.

In the CSG (204) shown in FIG. 2 the vertical axis indicates the time (206), typically recording time after the activation of the seismic source, and the horizontal axis indicates the offset (208). In some embodiments, direct seismic waves (122), refracted seismic waves (110), and reflected seismic waves (114) may be located in the CSG (204) by their arrival times, i.e., the times instants they are first detected by the seismic receivers (116). The location of a particular type of wave in seismic data acquired in time and space, such as in CSG (204), may be termed as an “arrival” or as an “event”. Events detected in an observed seismic dataset (202) that are related to geological discontinuities (112) including the free surface may be considered as events of seismic reflectivity (207).

The CSG (204) illustrates how the arrivals are detected at later times by the seismic receivers (116) that are farther from the seismic source (106). In some embodiments, arrivals may have distinctive geometric shapes (209). For example direct seismic waves (122) in the CSG (204) may be characterized by a straight line, while arrivals of reflected seismic waves (114) may present a hyperbolic shape, as seen in FIG. 2. Refracted seismic waves (110) may be characterized by arrivals in a form that approximates a straight line.

In one or more embodiments, an observed seismic dataset (202) acquired by a seismic acquisition system (100) may be arranged in a plurality of CSGs (210) to create a 3D seismic dataset, as illustrated in FIG. 2. Alternatively, the observed seismic dataset (202) may be represented as a “seismic volume” (212) consisting of a plurality of time-space waveforms with a time axis (214), a first spatial dimension (216), and a second spatial dimension (218), where the first spatial dimension (216) and second spatial dimension (218) are orthogonal and span the Earth's surface above the subsurface region of interest (102).

An observed seismic dataset (202) may be processed by a seismic processor (220) to generate a seismic velocity model (219) of the subsurface region of interest (102). A seismic velocity model (219) is a representation of seismic velocity at a plurality of locations within a subsurface region of interest (102). Seismic velocity is the speed at which a seismic wave, that may be a pressure-wave or a shear-wave, travel through a medium. Pressures waves are often referred to as “primary-waves” or “P-waves”. Shear waves are often referred to a “secondary waves” or “S-waves”. Seismic velocities in a seismic velocity model (219) may vary in vertical depth, in one or more horizontal directions, or both. Layers of rock may be created from different materials or created under varying conditions. Each layer of rock may have different physical properties from neighboring layers and these different physical properties may include seismic velocity.

In some embodiments, an observed seismic dataset (202) may be processed by a seismic processor (220) to generate a seismic image (230) of the subsurface region of interest (102). For example, a time-domain seismic image (232) may be generated using a process called seismic migration (also referred to as “migration” herein) using a seismic velocity model (219). In seismic migration, events of seismic reflectivity recorded at the surface are relocated in either time or space to the locations the events occurred in the subsurface. In some embodiments, migration may transform pre-processed shot gathers from a time-domain to a depth-domain seismic image (234). In a depth-domain seismic image (234), seismic events in a migrated shot gather may represent geological boundaries (236, 238) in the subsurface. Various types of migration algorithms may be used in seismic imaging. For example, one type of migration algorithm corresponds to reverse time migration.

As illustrated in FIG. 2, processing of an observed seismic dataset (202) may generate a seismic image (230) that may reveal the three-dimensional geometry of a subsurface region of interest (102). In particular, the geological boundaries (236, 238) may delineate a hydrocarbon reservoir (104). Identifying geological boundaries (236, 238) and other geological objects, such as faults, may be performed using a seismic interpretation workstation. If a seismic image (230) indicates the potential presence of hydrocarbons in the subsurface region of interest (102), a wellbore may be planned using a wellbore planning system. Further, a drilling system may drill a wellbore (118) to confirm the presence of those hydrocarbons.

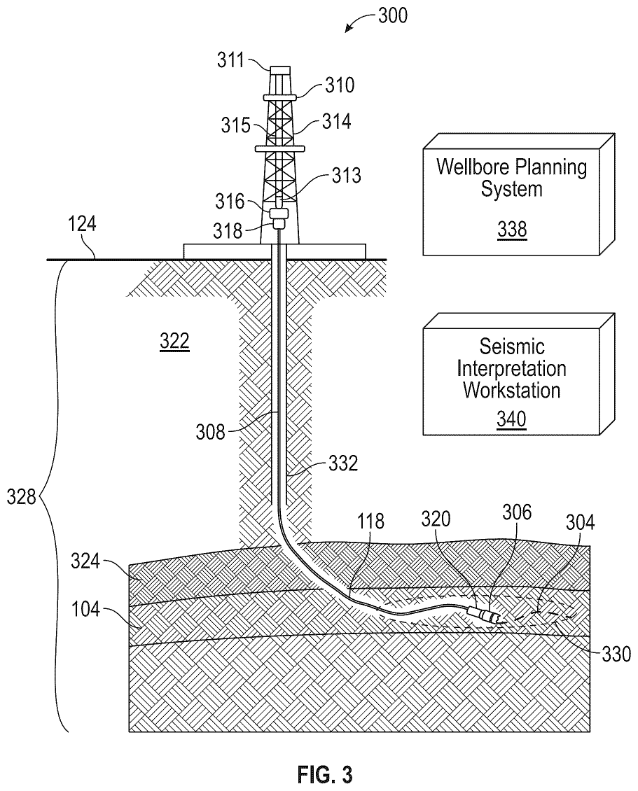

FIG. 3 shows a drilling system (300) in accordance with one or more embodiments. As shown in FIG. 3, a wellbore (118) following a wellbore trajectory (304) may be drilled by a drill bit (306) attached by a drillstring (308) to a drilling rig (310) located on the surface (124) of the earth. The drilling rig (310) may include framework, such as a derrick (314) to hold drilling machinery. A crown block (311) may be mounted at the top of the derrick (314), and a traveling block (313) may hang down from the crown block (311) by means of a cable (315) or drilling line. One end of the cable (315) may be connected to a drawworks (not shown), which is a reeling device that may be used to adjust the length of the cable (315) so that the traveling block (313) may move up or down the derrick (314).

A top drive (316) provides clockwise torque via the drive shaft (318) to the drillstring (308) in order to drill the wellbore (118). The drillstring (308) may comprise a plurality of sections of drillpipe attached at the uphole end to the drive shaft (318) and downhole to a bottomhole assembly (“BHA”) (320). The BHA (320) may be composed of a plurality of sections of heavier drillpipe and one or more measurement-while-drilling (“MWD”) tools configured to measure drilling parameters, such as torque, weight-on-bit, drilling direction, temperature, etc., and one or more logging tools configured to measure parameters of the rock surrounding the wellbore (118), such as electrical resistivity, density, sonic propagation velocities, gamma-ray emission, etc. MWD and logging tools may include sensors and hardware to measure downhole drilling parameters, and these measurements may be transmitted to the surface (124) using any suitable telemetry system known in the art. The BHA (320) and the drillstring (308) may include other drilling tools known in the art but not specifically shown.

The wellbore (118) may traverse a plurality of overburden (322) layers and one or more formations (324) to a hydrocarbon reservoir (104) within the subterranean region (328), and specifically to a drilling target (330) within the hydrocarbon reservoir (104). The wellbore trajectory (304) may be a curved or a straight trajectory. All or part of the wellbore trajectory (304) may be vertical, and some parts of the wellbore trajectory (304) may be deviated or have horizontal sections. One or more portions of the wellbore (118) may be cased with casing (332) in accordance with a wellbore plan.

To start drilling, or “spudding in” the well, the hoisting system lowers the drillstring (308) suspended from the derrick (314) towards the planned surface location of the wellbore (118). An engine, such as an electric motor, may be used to supply power to the top drive (316) to rotate the drillstring (308) through the drive shaft (318). The weight of the drillstring (308) combined with the rotational motion enables the drill bit (306) to bore the wellbore (118).

The drilling system (300) may be disposed at and communicate with other systems in the well environment, such as a seismic processor (220) and a wellbore planning system (338). The drilling system (300) may control at least a portion of a drilling operation by providing controls to various components of the drilling operation. In one or more embodiments, the drilling system (300) may receive well-measured data from one or more sensors and/or logging tools arranged to measure controllable parameters of the drilling operation. During operation of the drilling system (300), the well-measured data may include mud properties, flow rates, drill volume and penetration rates, rock physical properties, etc.

In some embodiments, the rock physical properties may be used by a seismic interpretation workstation (340) to help determine a location of a hydrocarbon reservoir (104). In some implementations, the rock physical properties and other subterranean features may be represented in a seismic image (230) that may be transferred from the seismic processor (220) to the seismic interpretation workstation (340). Knowledge of the existence and location of the hydrocarbon reservoir (104) and the seismic image (230) may be transferred from the seismic interpretation workstation (340) to a wellbore planning system (338). The wellbore planning system (338) may use information regarding the hydrocarbon reservoir (104) location to plan a well, including a wellbore trajectory (304) from the surface (124) of the earth to penetrate the hydrocarbon reservoir (104). In addition, to the depth and geographic location of the hydrocarbon reservoir (104), the planned wellbore trajectory (304) may be constrained by surface limitations, such as suitable locations for the surface position of the wellhead, i.e., the location of potential or preexisting drilling rigs, drilling ships or from a natural or man-made island.

Typically, the wellbore plan is generated based on best available information at the time of planning from a geophysical model, geomechanical models encapsulating subterranean stress conditions, the trajectory of any existing wellbores (which it may be desirable to avoid), and the existence of other drilling hazards, such as shallow gas pockets, over-pressure zones, and active fault planes. Information regarding the planned wellbore trajectory (304) may be transferred to the drilling system (300) described in FIG. 3. The drilling system (300) may drill the wellbore (118) along the planned wellbore trajectory (304) to access the drilling target (330) in the hydrocarbon reservoir (104).

From the above discussion, it is apparent that the accuracy of a seismic image (230) has important implications in the planning of hydrocarbon search and production. A seismic image (230) of high resolution may be obtained if densely-recorded data is acquired by using closely-spaced seismic sources (106) and seismic receivers (116). For example, seismic waves with a bandwidth extending up to 100 Hz or more may resolve thin features of a subsurface region of interest (102). However, some processing techniques may introduce errors that degrade the accuracy of the seismic image (230). For example, an observed seismic dataset (202) may be transformed into different domains of representation more suitable to characterize seismic energy. Time-space data may be transformed to and from a frequency-wavenumber domain by application of forward and inverse Fourier Transforms. Because the discrete Fourier Transform is not exact for data that are finite and aperiodic like seismic data are, its application to an observed seismic dataset (202) may introduce artifacts beyond the finite ranges of time or frequency of seismic energy. The generation of such artifacts is sometimes termed “edge effects”.

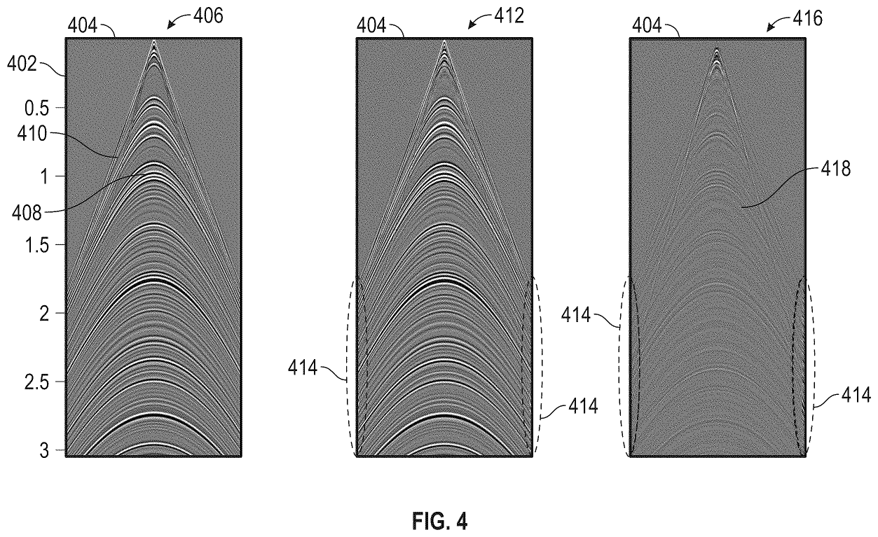

An example of edge effects introduced by processing a CSG with a multiple-removal filter is illustrated in FIG. 4. In all three CSGs in FIG. 4, the time in milliseconds is indicated by the vertical axis (402) and a horizontal dimension is indicated by the horizontal axis (404). CSG (406) is generated via numerical simulations of seismic wave propagation. Hyperbolic shaped reflections (408) and almost linear events from refractions (410) are observed in FIG. 4. As it may be also the case for an observed seismic dataset (202) acquired by a seismic acquisition system (100), the simulated CSG (406) is more limited in space and time than the events of seismic reflectivity (408, 410). In other words, events of seismic reflectivity (408, 410) may be truncated (i.e., the amplitude suddenly becomes zero) at the edges of the simulated CSG (406).

The CSG (406) is processed with a filtering algorithm known as Robust Estimation of Primaries by Sparse Inversion (R-EPSI), to remove waves reflected at the free-surface (also referred to as “multiples”). The R-EPSI algorithm, which estimates the free-surface Green's function of the subterranean region to simulate the multiples and subtract them from the CSG, involves performing forward and inverse Fourier Transforms. Therefore, an observed seismic dataset (202) processed with the R-EPSI algorithm may contain artifacts related to edge effects. CSG (412) shows the wavefield obtained after filtering CSG (406) with the R-EPSI algorithm. As seen in the dashed ellipses (414), edge effect artifacts contaminate the filtered CSG (412). The edge effect artifacts are better visualized in CSG (416) that shows the difference between the simulated CSG (406) and the filtered CSG (412). Thus, CSG (416) contains the removed multiples (418) besides the edge effect artifacts.

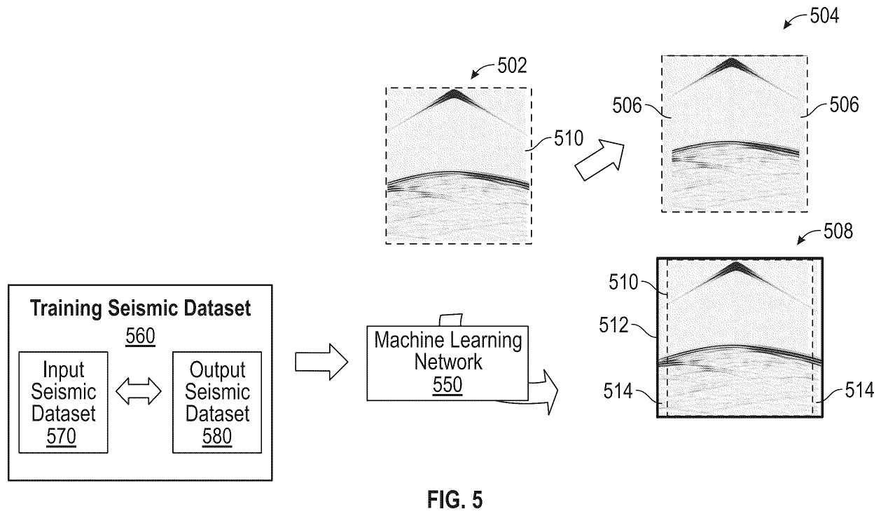

In some embodiments, applying mathematical operations to the observed seismic dataset (202) such as the R-EPSI algorithm may be preceded by tapering the wavefield to reduce edge effects. FIG. 5 illustrates an example of tapering an observed seismic dataset before applying any filtering or transformation. An observed seismic dataset (502) and the observed seismic dataset after tapering (504), respectively, are presented. Tapering may involve reducing smoothly (i.e., without strong discontinuities) to zero the amplitude of the events in the observed seismic dataset (502), by making use of tapering windows. Examples of tapering windows include, among others, linear windows, or cosine-based windows. After tapering, some regions of the observed seismic dataset (502) may have zero amplitudes, such as regions (506) in FIG. 5. However, even though application of tapering windows may reduce edge effects, part of the observed seismic dataset (502) is lost when tapered to zero.

According to some embodiments, an observed seismic dataset (502) may be extrapolated to a domain that extends beyond its domain, to avoid data loss from tapering. The domain of the observed seismic dataset (510) is indicated by the dashed rectangle in FIG. 5. The observed seismic dataset (502) may be extrapolated to generate what is referred to herein as an extended seismic dataset (508). The domain of the extended seismic dataset (512) is indicated by the continuous rectangle. The domain difference (514), i.e., the difference between the two domains may be used for data tapering. In some embodiments, the extended seismic dataset (508) may be obtained by extending the observed seismic dataset (502) along one dimension, as shown in FIG. 5. One with ordinary skill in the art will recognize that extrapolating an observed seismic dataset (202) to a larger domain can be done in 1, 2 or more data dimensions.

Furthermore, modelling assumptions may be avoided by extrapolating the observed seismic dataset (502) with a ML network (550). The ML network (550) may be trained with a training seismic dataset (560) that in some embodiments may include at least an input seismic dataset (570) and an output seismic dataset (580). The input seismic dataset (570) may be associated to a domain of first extent, and the output seismic dataset (580) may be associated to a domain of second extent that may be larger than the domain of first extent. In some embodiments, the extent (“range”, or “aperture”) may be a spatial distance over which the input seismic dataset is recorded or observed, while in other embodiments the extent may be a temporal window over which the input seismic dataset may be recorded. Typically, the seismic dataset may be recorded (in the case of the input seismic dataset) or predicted (in the case of the output seismic dataset at uniform intervals within the extent, although unequal, variable, or random intervals should be understood as falling within the scope of the invention. The domain of second extent may be obtained by extending the domain of first extent along one or more dimensions. According to some embodiments, the extended seismic dataset (508) may be generated by extending the domain of the observed seismic dataset (510) in the same one or more dimensions used to obtain the domain of second extent.

Machine learning (ML), broadly defined, is the extraction of patterns and insights from data. The phrases “artificial intelligence”, “machine learning”, “deep learning”, and “pattern recognition” are often convoluted, interchanged, and used synonymously throughout the literature. This ambiguity arises because the field of “extracting patterns and insights from data” was developed simultaneously and disjointedly among a number of classical arts like mathematics, statistics, and computer science. The term machine learning will be adopted herein. However, one skilled in the art will recognize that the concepts and methods detailed hereafter are not limited by this choice of nomenclature.

Machine-learning networks types may include, but are not limited to, generalized linear models, Bayesian regression, random forests, and deep models such as neural networks, convolutional neural networks, and recurrent neural networks. ML network types, whether they are considered deep or not, are usually associated with additional “hyperparameters” which further describe the model. For example, hyperparameters providing further detail about a neural network may include, but are not limited to, the number of layers in the neural network, choice of activation functions, inclusion of batch normalization layers, and regularization strength. It is noted that in the context of machine learning (ML), the regularization of a ML network (550) refers to a penalty applied to the loss function of the ML network (550) and should not be confused with the regularization of a seismic dataset. Commonly, in the literature, the selection of hyperparameters surrounding a ML network (550) is referred to as selecting the model “architecture”.

In some embodiments, once a ML network (550) type and hyperparameters have been selected, the ML network (550) is “trained” to perform a task. In some implementations, the ML network (550) is trained using supervised learning. A training seismic dataset (560) for supervised learning consists of pairs of input and output seismic datasets. The output seismic datasets (580) represent desired outputs, upon processing the input seismic datasets (570). During training, the ML network (550) processes at least one input seismic dataset (570) from the training seismic dataset (560) and produces at least one predicted dataset. Each predicted dataset is compared to the output seismic dataset (580) associated to the input seismic dataset (570). The comparison of the predicted dataset to the output seismic dataset (580) may be performed in an iterative manner until a termination criterion is satisfied, and the ML network (550) may be said to be trained.

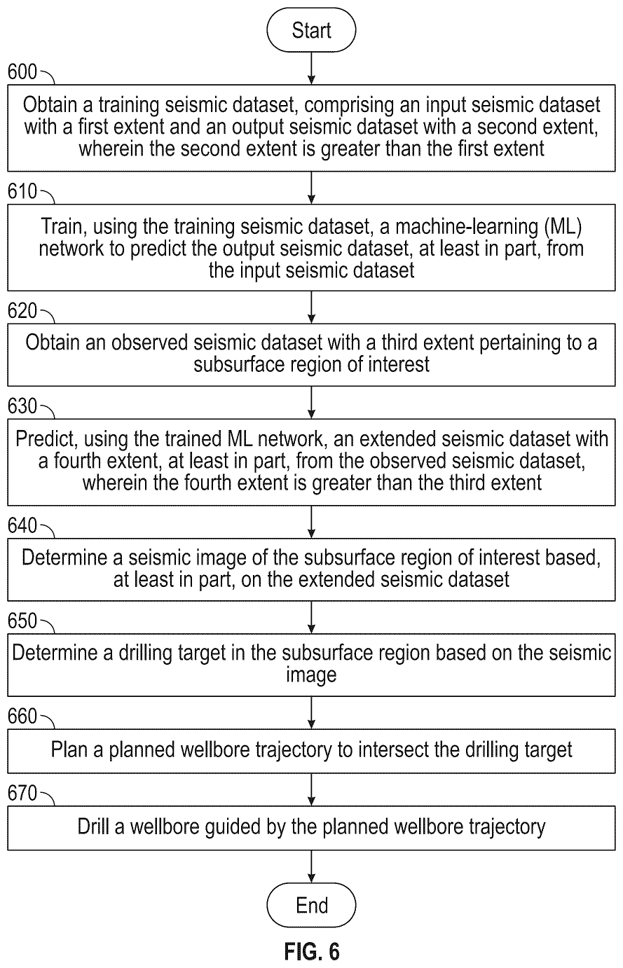

Turning to FIG. 6, FIG. 6 shows a flowchart in accordance with one or more embodiments. Specifically, FIG. 6 describes a general method to extrapolate an observed seismic dataset (202) to reduce edge effect artifacts introduced by seismic processing. While the various blocks in FIG. 6 are presented and described sequentially, one of ordinary skill in the art will appreciate that some or all of the blocks may be executed in different orders, may be combined or omitted, and some or all of the blocks may be executed in parallel. Furthermore, the blocks may be performed actively or passively.

In Block 600, a training seismic dataset is obtained, in accordance with one or more embodiments. The training seismic dataset (560) includes an input seismic dataset (570) with a first extent and an output seismic dataset (580) with a second extent. The second extent is greater than the first extent. The first extent and the second extent may relate to the time-space dimensions of the training seismic dataset (560). In some embodiments the first extent and the second extent may relate only to a spatial extent.

The training seismic dataset (560) may be acquired with a seismic acquisition system (100) and/or obtained from numerical simulations of wave propagation. The training seismic dataset (560) may further include a synthetic seismic dataset generated with statistical techniques to mimic features of seismic data observed in acquired or simulated seismic datasets. Further, other schemes can be implemented to generate the synthetic seismic dataset without departing from the scope of this disclosure.

In some embodiments, synthetic events of seismic reflectivity (hereinafter “synthetic events”) may be generated to produce a training seismic dataset (560). The synthetic events are generated to be similar to events of seismic reflectivity (207) of observed seismic datasets (202). Generating a training seismic dataset (560) to correctly mimic events of seismic reflectivity (207) in observed seismic datasets (202) may include using a high number of synthetic events, since the physical laws governing seismic wave propagation may not be explicitly used in training. The quantity and diversity of a training seismic dataset (560) appears to be more effective for training than the selection of a particular ML network (550) used for extrapolation. However, using observed seismic datasets (202) to form a training seismic dataset (560) may be costly in time and resources because it may involve numerous data acquisition campaigns. On the other hand, generating a comprehensive training seismic dataset (560) via numerical simulations may be also difficult due to (i) a high demand of computational resources, (ii) inaccuracies and instabilities related to numerical techniques, and (iii) not enough information available to build the physical model of the subsurface.

In one or more embodiments of the instant disclosure, the synthetic events may be generated using randomly generated geometric shapes. Synthetic seismic datasets generated in this manner can cover a broad range of events of seismic reflectivity (207) and can mimic real seismic datasets without minimal modeling assumptions and computational cost. The synthetic events may include geometric shapes (209) representative of a geometrical trajectory in space-time present in the observed seismic dataset (202). In some embodiments, synthetic events may be generated for training data arranged in the form of a common shot gather. One of ordinary skill in the art will appreciate that synthetic events may be identified and generated in other possible arrangements of seismic data, for example, in the form of stacked seismic data. In a common shot gather synthetic events may present specific geometric shapes (209), for example, hyperbolic shapes and piecewise linear shapes, as illustrated by events FIGS. 2 and 5.

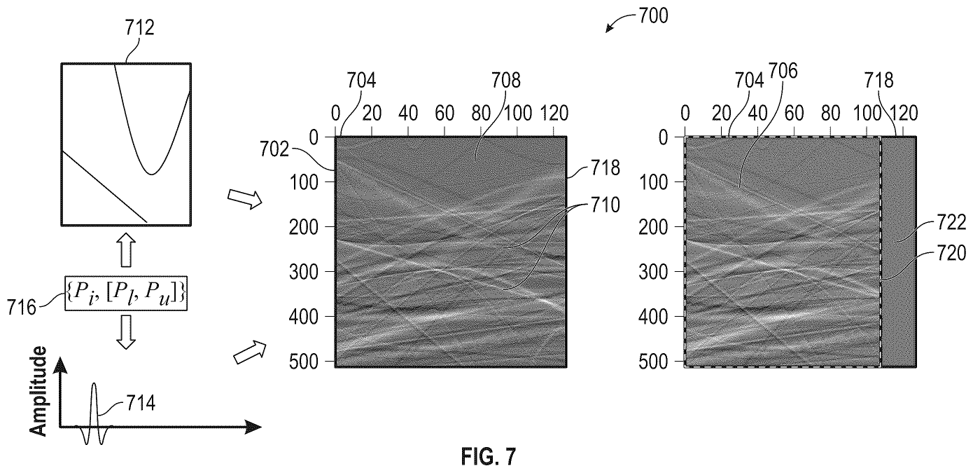

FIG. 7 shows an example of a synthetic seismic dataset (700) in the form of CSGs, according to one or more embodiments. The synthetic seismic dataset (700) includes an input seismic dataset (706) and the output seismic dataset (708). The horizontal axis (704) indicates the receiver number and the vertical axis (702) indicates the time sample number. The output seismic dataset (708) is composed of synthetic events (710) of seismic reflectivity generated using geometric shapes (712) similar to those found in observed seismic datasets (202). As shown in FIG. 7, the synthetic events (710) may include convex and concave hyperbolic events, linear events and positive and negative dips. Furthermore, in some embodiments each synthetic event (710) may be generated by convolving geometric shapes (712) with seismic wavelets (714). With the use of seismic wavelets (714) the synthetic events (710) may mimic the frequency content of observed seismic datasets (202).

As seen in FIG. 7, the synthetic events (710) span a domain of a second extent (718) that is larger than and includes the domain of first extent (720). In FIG. 7, the domain of first extent (720) is indicated by the dashed rectangle and the domain of second extent (718) is indicated by the continuous rectangle. The domain of second extent (718) includes regions (722) in which the observed seismic dataset (202) is extended. The size of such extrapolation regions may be a user's choice. As a non-limiting example, a size of the extrapolation region (722) in a dimension may be 10% of the size of the domain of first extent (720) in the corresponding dimension.

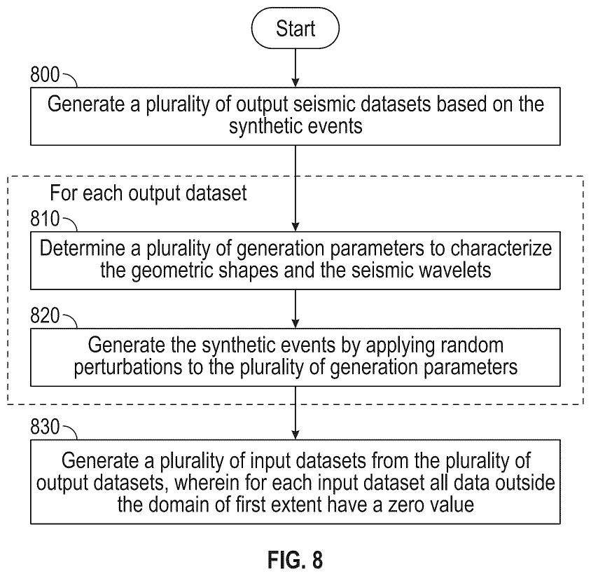

FIG. 8 illustrates a method to the generate a synthetic seismic dataset (700) including a plurality of input seismic datasets (706) and a plurality of output seismic datasets (708). In Block 800, a plurality of output seismic datasets (708) may be generated based on the plurality of synthetic events (710). For each output seismic dataset (708) the geometric shapes (712) and the seismic wavelets (714) may be parametrized and a plurality of generation parameters (716) may then be determined, as shown in Block 810.

In accordance with one or more embodiments, the generation parameters (716) may be defined, by a user, as ranges or sets. For example, a user may prescribe a lower and an upper bound for the number of geometric shapes in a synthetic dataset. The lower and upper bound for the number of geometric shapes may be denoted by as Nₗ and Nᵤ, respectively. In the case of a linear line the generation parameters (716) may include a range for acceptable linear slopes (lower bound mₗ and upper bound mᵤ). Other non-limiting examples of generation parameters (716) for the geometric shapes (712) may include, for example, location in the data domain, amplitude distortion, polarization and curvature of hyperbola.

In accordance with one or more embodiments, the generation parameters (716) also include a set of seismic wavelets (714) and one or more methods for injecting noise into the synthetic seismic dataset (700). Examples of seismic wavelets (714) that may be used are the Ricker wavelet, the Gaussian wavelet, Ormsby wavelet, Klauder wavelet, the first derivative of the Gaussian wavelet, or any other wavelet known in the art. Generation parameters (716) for the seismic wavelets (714) may include dominant frequency, frequency range, amplitude and type of wavelet, among others. In one or more embodiments, the amplitude and/or frequency range of the seismic wavelet (714) may be a function of time or depth. For example, the amplitude may be defined to decrease at a given rate according to time or depth to mimic attenuation phenomena. Changing the frequency range of the seismic wavelet (714) as a function of time or depth mimics observed seismic datasets (202) where the temporal frequency bandwidth is not stationary or constant for all events of seismic reflectivity (207). The functional relationship between time or depth and the seismic wavelet (714) parameters may be defined by the user.

In some embodiments, generation parameters (716) include noise parameters. Various types of noise may be added to the synthetic seismic dataset (700). For example, random noise may be superimposed to each of the waveforms in the synthetic events. The strength of the noise may be described by a variance. In one or more embodiments, the generation parameters (716) include the range of available noise variances. In one or more embodiments, static noise may also be applied to the synthetic events (710). Static noise may be applied by shifting in time or depth, by a prescribed amount (e.g., random), the traces in the seismic dataset. Further, in one or more embodiments, the amplitudes of various waveforms may be altered (e.g., multiplied by a random factor). Such an alteration injects noise into the synthetic events (710) and is intended to mimic variation in seismic receiver (116) sensitivities or couplings. One with ordinary skill in the art will appreciate that noise can be added to the synthetic events (710) in variety of ways and that not all noise injection schemes can be enumerated herein. Further, any noise injection scheme can be applied to the synthetic events (710) without departing from the scope of this disclosure.

In some embodiments, the synthetic events (710) may be generated by applying random perturbations to the plurality of generation parameters (716), as indicated in Block 820. For example, a range of probable values for a particular generation parameter may specified with a lower and an upper bound denoted by Pₗ and Pᵤ, respectively, where 0<Pₗ≤Pᵤ. The value of the particular generation parameter may be determined by randomly selecting a value Pᵢ greater than or equal to Pₗ and less than or equal to Pᵤ. In one or more embodiments, the probability of selecting a value Pᵢ within a user-provided range need not be uniform across the range. In this case, the user also specifies the probability distribution for the available number of synthetic events (710) that can be selected as part of the generation parameters (716). However, one with ordinary skill in the art will recognize that many alterations to the generation of the synthetic events (710) can be made without departing from the scope of this disclosure and that these alterations may necessitate fewer or additional generation parameters (716).

Returning to FIG. 8, in Block 830 a plurality of input seismic datasets (706) may be generated from the plurality of output seismic datasets (708). Specifically, each input seismic dataset (706) may be obtained by muting, i.e., multiplying by zero, all data in an output seismic dataset (708) that is outside the domain of first extent (720). An example of an input seismic dataset obtained with such operation is shown in CSG (706) where data beyond the domain of first extent (720) are zero, while the data in the rest of the domain of second extent (718) remain equal to data in the output seismic dataset (708). To one of ordinary skill in the art it will be apparent that the input seismic dataset (706) may be obtained by multiplying data by zero along other dimensions, such as, for example, beyond a certain receiver number.

By repeating the synthetic data generation process described in Blocks (810)-(830) of FIG. 8, a plurality of output seismic datasets (708) and a plurality of input seismic datasets (706) may be formed. Each synthetic seismic dataset (700) may include pairs of output seismic datasets (708) and accompanying input seismic datasets (706). Each output seismic dataset (708) may be generated directly with the generation parameters (716) and does not make use of modelling processes and assumptions. Each output seismic dataset (708) may include one or more synthetic events (710) spanning the domain of second extent (718). Each synthetic event (710) of an output seismic dataset (708) may have an associated geometric shape (712) and a seismic wavelet (714). On the other hand, each input seismic dataset (706) may be identical to the output seismic dataset (708) within the domain of first extent (720), and zero in the region (722) outside the domain of first extent (720).

Returning to FIG. 6, in Block 610, a machine-learning (ML) network (550) is trained to predict the output seismic dataset (580) from the input seismic dataset (570). The objective of the ML network (550) is to extrapolate a given input seismic dataset (570). In accordance with one or more embodiments, the ML network type may be a convolutional neural network (CNN). A CNN may be more readily understood as a specialized neural network (NN). One with ordinary skill in the art will recognize that any variation of the NN or CNN (or any other ML network) may be employed without departing from the scope of this disclosure. Further, it is emphasized that the following discussions of a NN and a CNN are basic summaries and should not be considered limiting.

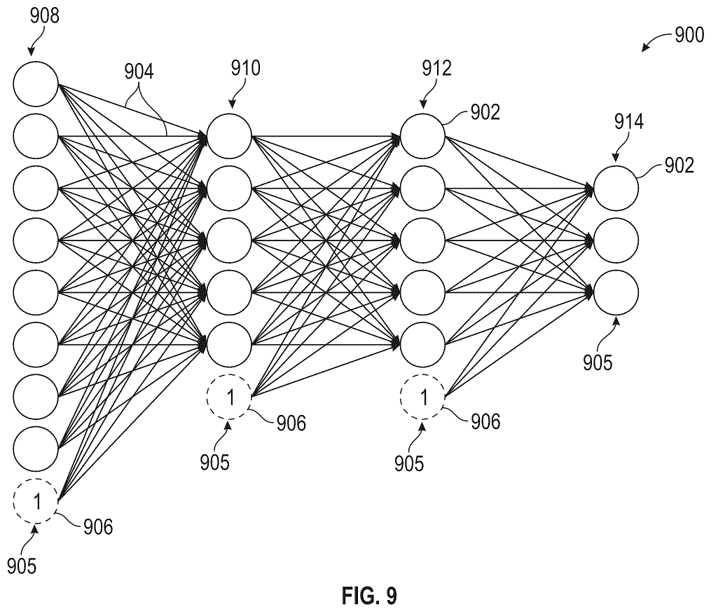

A diagram of a neural network is shown in FIG. 9. At a high level, a neural network (900) may be graphically depicted as being composed of nodes (902), where here any circle represents a node, and edges (904), shown here as directed lines. The nodes (902) may be grouped to form layers (905). FIG. 9 displays four layers (908, 910, 912, 914) of nodes (902) where the nodes (902) are grouped into columns, however, the grouping need not be as shown in FIG. 9. The edges (904) connect the nodes (902). Edges (904) may connect, or not connect, to any node(s) (902) regardless of which layer (905) the node(s) (902) is in. That is, the nodes (902) may be sparsely and residually connected. A neural network (900) will have at least two layers (905), where the first layer (908) is considered the “input layer” and the last layer (914) is the “output layer”. Any intermediate layer (910, 912) is usually described as a “hidden layer”. A neural network (900) may have zero or more hidden layers (910, 912) and a neural network (900) with at least one hidden layer (910, 912) may be described as a “deep” neural network or as a “deep-learning method”. In general, a neural network (900) may have more than one node (902) in the output layer (914). In this case the neural network (900) may be referred to as a “multi-target” or “multi-output” network.

Nodes (902) and edges (904) carry additional associations. Namely, every edge is associated with a numerical value. The edge numerical values, or even the edges (904) themselves, are often referred to as “weights” or “parameters”. While training a neural network (900), numerical values are assigned to each edge (904). Additionally, every node (902) is associated with a numerical variable and an activation function. Activation functions are not limited to any functional class, but traditionally follow the form:

$$A = f ( {\sum }_{i ∈ ( incoming )} [ {( node value )}_{i} {( edge value )}_{i} ] ) \qquad Equation ( 1 )$$

where i is an index that spans the set of “incoming” nodes (902) and edges (904) and ƒ is a user-defined function. Incoming nodes (902) are those that, when viewed as a graph (as in FIG. 9), have directed arrows that point to the node (902) where the numerical value is being computed. Some functions for ƒ may include the linear function ƒ(x)=x, sigmoid function ƒ=1/[1+exp(−x)], and rectified linear unit function ƒ(x)=max(0, x), however, many additional functions are commonly employed. Every node (902) in a neural network (900) may have a different associated activation function. Often, as a shorthand, activation functions are described by the function ƒ by which it is composed. That is, an activation function composed of a linear function ƒ may simply be referred to as a linear activation function without undue ambiguity.

When the neural network (900) receives an input, the input is propagated through the network according to the activation functions and incoming node (902) values and edge (904) values to compute a value for each node (902). That is, the numerical value for each node (902) may change for each received input. Occasionally, nodes (902) are assigned fixed numerical values, such as the value of 1, that are not affected by the input or altered according to edge (904) values and activation functions. Fixed nodes (902) are often referred to as “biases” or “bias nodes” (906), displayed in FIG. 9 with a dashed circle.

In some implementations, the neural network (900) may contain specialized layers (905), such as a normalization layer, or additional connection procedures, like concatenation. One skilled in the art will appreciate that these alterations do not exceed the scope of this disclosure.

As noted, the training procedure for the neural network (900) comprises assigning values to the edges (904). To begin training, the edges (904) are assigned initial values. These values may be assigned randomly, assigned according to a prescribed distribution, assigned manually, or by some other assignment mechanism. Once edge (904) values have been initialized, the neural network (900) may act as a function, such that it may receive inputs and produce an output. As such, at least one input is propagated through the neural network (900) to produce an output.

A training seismic dataset (560) is provided to the neural network (900). A training seismic dataset (560) consists of pairs consisting of an input seismic dataset (570) and an output seismic dataset (580). Each neural network (900) predicted dataset is compared to the associated output seismic dataset (580). The comparison of the neural network (900) predicted dataset to the output seismic dataset (580) is typically performed by a so-called “loss function”; although other names for this comparison function such as “error function”, “misfit function”, and “cost function” are commonly employed. Many types of loss functions are available, such as the mean-squared-error function, the Huber loss function, however, the general characteristic of a loss function is that the loss function provides a numerical evaluation of the similarity between the neural network (900) output and the associated target. The loss function may also be constructed to impose additional constraints on the values assumed by the edges (904), for example, by adding a penalty term, which may be physics-based, or a regularization term (not be confused with regularization of seismic data).

Generally, the goal of a training procedure is to alter the edge (904) values to promote similarity between the neural network (900) output and associated target over the training seismic dataset (560). Thus, the loss function is used to guide changes made to the edge (904) values, typically through a process called “backpropagation”. While a full review of the backpropagation process exceeds the scope of this disclosure, a brief summary is provided. Backpropagation consists of computing the gradient of the loss function over the edge (904) values. The gradient indicates the direction of change in the edge (904) values that results in the greatest change to the loss function. Because the gradient is local to the current edge (904) values, the edge (904) values are typically updated by a “step” in the direction indicated by the gradient. The step size is often referred to as the “learning rate” and need not remain fixed during the training process. Additionally, the step size and direction may be informed by previously seen edge (904) values or previously computed gradients. Such methods for determining the step direction are usually referred to as “momentum” based methods.

Once the edge (904) values have been updated, or altered from their initial values, through a backpropagation step, the neural network (900) will likely produce different outputs. Thus, the procedure of propagating at least one input through the neural network (900), comparing the neural network (900) output with the associated target with a loss function, computing the gradient of the loss function with respect to the edge (904) values, and updating the edge (904) values with a step guided by the gradient, is repeated until a termination criterion is reached. Common termination criteria are: reaching a fixed number of edge (904) updates, otherwise known as an iteration counter; a diminishing learning rate; noting no appreciable change in the loss function between iterations; reaching a specified performance metric as evaluated on the data or a separate hold-out dataset. Once the termination criterion is satisfied, and the edge (904) values are no longer intended to be altered, the neural network (900) is said to be “trained.”

A CNN is similar to a neural network (900) in that it can technically be graphically represented by a series of edges (904) and nodes (902) grouped to form layers. However, it is more informative to view a CNN as structural groupings of weights; where here the term structural indicates that the weights within a group have a relationship. CNNs are widely applied when the data inputs also have a structural relationship, for example, a spatial relationship where one input is always considered “to the left” of another input. Images have such a structural relationship. A seismic dataset may be organized and visualized as an image. Consequently, a CNN is an intuitive choice for processing a seismic dataset.

A structural grouping, or group, of weights is herein referred to as a “filter”. The number of weights in a filter is typically much less than the number of inputs, where here the number of inputs refers to the number of pixels in an image or the number of trace-time (or trace-depth) values in a seismic dataset. In a CNN, the filters can be thought as “sliding” over, or convolving with, the inputs to form an intermediate output or intermediate representation of the inputs which still possesses a structural relationship. Like unto the neural network (900), the intermediate outputs are often further processed with an activation function. Many filters may be applied to the inputs to form many intermediate representations. Additional filters may be formed to operate on the intermediate representations creating more intermediate representations. This process may be repeated as prescribed by a user. There is a “final” group of intermediate representations, wherein no more filters act on these intermediate representations. In some instances, the structural relationship of the final intermediate representations is ablated; a process known as “flattening”. The flattened representation may be passed to a neural network (900) to produce a final output. Note, that in this context, the neural network (900) is still considered part of the CNN. Like unto a neural network (900), a CNN is trained, after initialization of the filter weights, and the edge (904) values of the internal neural network, if present, with the backpropagation process in accordance with a loss function.

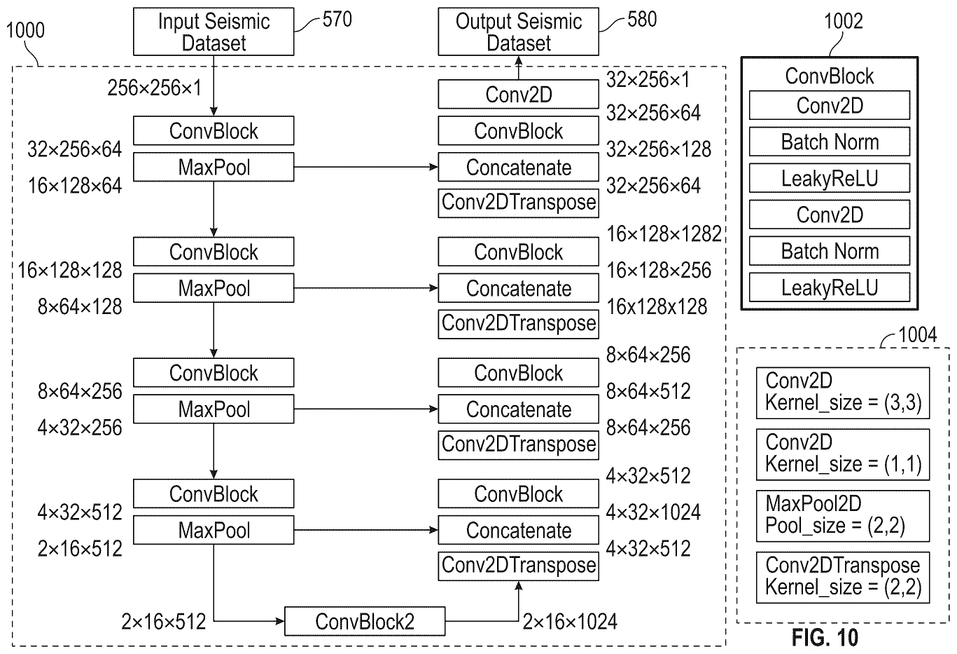

In accordance with one or more embodiments, the architecture of the CNN (1000) is depicted in FIG. 10. The CNN (1000) accepts an observed seismic dataset (202) as an input. The CNN (1000) processes the observed seismic dataset (202) with a series of convolutional blocks, pooling operations, transpose (or upsampling) operations, and concatenations. The components of a convolutional block, in accordance with the CNN (1000) architecture depicted in FIG. 10, are shown in the ConvBlock legend (1002). As shown, each convolutional block consists of a 2-dimensional convolution operation, followed by a batch normalization operation, followed by a leaky ReLu activation function, repeated two times.

In accordance with one or more embodiments, FIG. 10 also depicts the values of the CNN hyperparameters (1004) governing the CNN (1000). The CNN hyperparameters (1004) indicate the size of the convolution kernel used in the convolutions of the CNN (1000), the size of the max pooling kernel, and the size of the transpose kernel, in accordance with one or more embodiments. The CNN hyperparameters (1004) may be selected by a user or may be identified during training using a set of data similar to the training seismic dataset (560) known as a validation set.

Additionally, FIG. 10 illustrates the relative size of the data throughout the operations of the CNN (1000). In the example of FIG. 10, the seismic dataset consist of 32 traces and each trace has 256 discrete time samples. The size of the data as it is processed by the CNN (1000) is dependent on the size of the input seismic dataset. As such, the relative data sizes depicted in FIG. 10 are given with respect to a seismic dataset with 32 traces each with 256 time samples, however, one with ordinary skill in the art will recognize that the CNN (1000) of FIG. 10 is not limited to this size of input. In general, the CNN (1000) of FIG. 10 can accept an input of almost any size so long as the convolutional operations and max pooling operations do not reduce the intermediate data below the defined kernel sizes of these operations, respectively. Using this example input size of 32 traces each with 256 time samples and the kernel sizes given in the CNN hyperparameters (1004), the first convolutional block of the CNN does not reduce the size of the input (indicating padding is used during the convolution operations) and generates 64 intermediate representations. Each of these intermediate representations are then processed by a max pooling operation which reduces the intermediate data size to 16 by 128 by 64. The intermediate data is both retained for later use (as a copy) and passed on to additional operations. Specifically, the intermediate data is processed by three more sets of convolutional blocks and max pooling operations, where a copy of the intermediate data is again retained after each max pooling operation, until the intermediate data is of the size 2 by 16 by 512. A convolutional block is then applied to double the number of intermediate representations, each of size 2 by 16. The CNN (1000) then applies a transpose operation which effectively increases, or upsamples, the size of the intermediate data. In the example of FIG. 10, after the first transpose operation, the size of each intermediate representation in the intermediate data is increased from 2 by 16 to 4 by 32, or doubled, due to the kernel size of the transpose operations being set to (2, 2). After transposition, the intermediate data is concatenated with a previously retained copy of the intermediate data from a previous operation. A convolutional block is applied to the concatenated data. This process of transposition, concatenation with a previous copy of intermediate data, and application of a convolutional block is applied three times. The result of this process is that each intermediate representation now has the same size as the initial input. The intermediate representations are then processed with a special convolutional operation with a kernel size of (1, 1). This effectively collapses the intermediate representations so to produce the output with the same size as the input seismic dataset (570). Therefore, if trained correctly, the CNN (1000) of FIG. 10 is configured to accept an input seismic dataset (570) and return an output seismic dataset (580), where the output seismic dataset (580) is the same size as the input seismic dataset (570) but it is non-zero outside the domain of first extent.

While an embodiment using a CNN (1000) for the ML network type has been suggested, one skilled in the art will appreciate that the instant disclosure is not limited to this ML network type. ML networks such as a random forest, visual transformers (ViTs), or non-parametric methods such as K-nearest neighbors or a Gaussian process may be readily inserted into this framework and do not depart from the scope of this disclosure.

In some embodiments, with a ML network type and associated architecture selected, the ML network (550) is trained using at least the plurality of input seismic datasets (570) and the plurality of output seismic datasets (580), as shown in Block 840 of FIG. 8. Each input seismic dataset (570) may have an associated output seismic dataset (580). During training, the input seismic dataset (570) may be provided to the ML network (550). The ML network (550) may process the input seismic dataset (570) and produce a predicted output. The predicted output may be compared to the associated output seismic dataset (580). In some embodiments, during training, the ML network (550) is adjusted such that the predicted output, upon receiving one or more input seismic datasets (570), is similar to the output seismic datasets (580).

Once the ML network (550) is trained, one or more input seismic datasets (570) may form a validation set and may be processed by the trained ML network (550) for validation. The predicted dataset is then compared to the associated output seismic datasets (580) of the validation set. Thus, the performance of the trained ML network (550) may be evaluated. An indication of the performance of the ML network (550) may be acquired by estimating the generalization error of the trained ML network (550). The generalization error is estimated by evaluating the performance of the trained ML network (550), after a suitable model has been found on the test set. One with ordinary skill in the art will recognize that the training procedure described herein is general and that many adaptions can be made without departing from the scope of the present disclosure. For example, common training techniques, such as early stopping, adaptive or scheduled learning rates, and cross-validation may be used during training without departing from the scope of this disclosure.

According to one or more embodiments, the trained ML network (550) may be retrained using transfer learning to process observed seismic datasets (202) of different type, domain, or number of dimensions. Transfer learning may be performed, for example, by using the values of the edges (904) of the trained ML network (550) as initial values of the ML network (550) to be trained with different observed seismic data. Training time may be significantly reduced by making use of transfer learning.

Returning to the method described in FIG. 6, in Block 620, an observed seismic dataset with a third extent regarding a subsurface region of interest is obtained, in accordance with one or more embodiments. The observed seismic dataset (202) may be acquired using a seismic acquisition system (100) above a subsurface region of interest (102). The observed seismic dataset (202) may also include simulated seismic data obtained with numerical simulations of wave propagation.

The observed seismic dataset (202) may be processed to attenuate noise and may be organized in one or more spatial dimensions (216, 218) and a time axis (214) to form a plurality of time-space waveforms. In some embodiments, one or more CSGs (210) may be generated with the source position corresponding to the middle of the offset, as illustrated in FIG. 2.

The observed seismic dataset (202) may include a plurality of events of seismic reflectivity (207) containing, among others, reflected (114) and refracted (110) seismic waves. The domain of observed seismic dataset (510) is with a third extent and may relate to the time range and the space range in which the observed seismic dataset (202) is acquired or simulated. In some embodiments each event of seismic reflectivity (207) may have a bandlimited frequency range due to a limited source bandwidth, and to filtering phenomena occurring as seismic energy propagates through the subsurface region of interest (102). Events of seismic reflectivity (408, 410) with a narrow frequency range are illustrated in FIG. 4. A non-limiting example of a frequency range for seismic data may be 5-60 Hz.

In Block 630, the extended seismic dataset (508) with a fourth extent is predicted from the observed seismic dataset (502) using the trained ML network (550). The fourth extent is greater than the third extent that is related to the observed seismic dataset (202). The trained ML network (550) is configured to receive the observed seismic dataset (502) and output an extended seismic dataset (508). The ML network (550) may extrapolate the observed seismic dataset (502) providing continuity in one or more data dimensions to the one or more events of seismic reflectivity (207) present in the observed seismic dataset (202).

In Block 640, a seismic image of the subsurface region of interest is determined based on the extended seismic dataset (508), in accordance with one or more embodiments. In some embodiments, the observed seismic dataset (202) may include a plurality of CSGs (210) and each CSG (204) may include a plurality of time-space waveforms, as illustrated in FIG. 2. The observed seismic dataset (202) may be extended and the resulting extended seismic dataset (508) may be processed to denoise and extract seismic data of interest (for example, events of seismic reflectivity (207)). The seismic data of interest may carry information about the geological discontinuities (112) or reflectors in the subsurface region of interest (102).

Processing to extract seismic data of interest may be performed for each CSG (204) of an extended seismic dataset (508), and the plurality of processed CSGs may then be used by the seismic processor (220) to generate a seismic image (230). For example, a partial seismic image may be generated for each of the plurality of filtered CSGs obtaining a plurality of partial seismic images. A stacked seismic image may then be constructed, for example, by summing all the partial seismic images.

In Block 650, a drilling target in the subsurface region may be determined based on the seismic image (230), in accordance with one or more embodiments. The seismic image (230) may be transferred to a seismic interpretation workstation (340). The seismic interpretation workstation (340) may use the seismic image (230) to determine the location of a drilling target (330). The location of the drilling target (330) in a wellbore (118) may be based on, for example, an expected presence of gas or another hydrocarbon within a seismic image (230). Locations in a seismic image (230) may indicate an elevated probability of the presence of a hydrocarbon and may be targeted by well designers. On the other hand, locations in a seismic image (230) indicating a low probability of the presence of a hydrocarbon may be avoided by well designers.

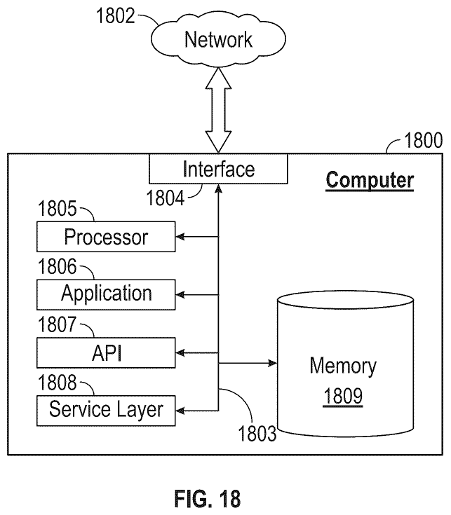

In Block 660, a wellbore trajectory (304) to intersect the drilling target (330) is planned, in accordance with one or more embodiments. Knowledge of the location of the drilling target (330) and the seismic image (230) may be transferred to a wellbore planning system (338). Instructions associated with the wellbore planning system (338) may be stored, for example, in the memory (1809) within the computer system (1800) described in FIG. 18 below. The wellbore planning system (338) may use the knowledge of the location of the drilling target (330) and of the seismic image (230) to plan a wellbore trajectory (304) within the subsurface region of interest (102).

In Block 670, a wellbore is drilled guided by the planned wellbore trajectory, in accordance with one or more embodiments. The wellbore planning system (338) may transfer the planned wellbore trajectory (304) to the drilling system (300) described in FIG. 3. The drilling system (300) may drill the wellbore (118) along the planned wellbore trajectory (304) to access and produce the hydrocarbon reservoir (104) to the surface (124).

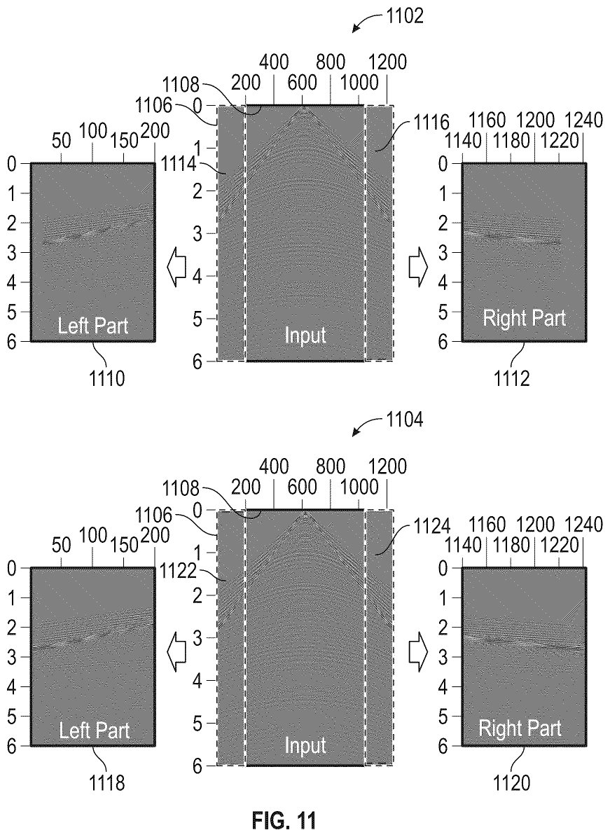

As a concrete example of the methods, processes, models, and techniques described herein, a plurality of synthetic datasets was generated, a ML network (550) was trained, and the results of the ML network (550) were evaluated on both simulated and real seismic datasets. These results will be shown in FIGS. 11-17 with an accompanying discussion herein. For the following examples, the training seismic dataset (560) consists of 9000 pairs that were generated using the processes described in FIG. 8. Each pair of the training seismic dataset (560) consists of an input seismic dataset (570) and an output seismic dataset (580). Data in the input seismic dataset (570) and output seismic dataset (580) are organized in the form of a common shot gather (CSG) (204) in a time-receiver domain. Data at the first 20 receivers and at the last 20 receivers of the input seismic dataset (706) is set equal to zero, at all time instants.

It is emphasized that no forward modelling process is used to generate the training seismic datasets (560). Rather, each training seismic dataset (560) is generated using a large number of geometric shapes as in the example of FIG. 7. That is, each training seismic dataset (560) is created using a varying number of synthetic events (710), which can have any shape, for example, but not limited to, linear and hyperbolic shapes. For the present examples, the seismic wavelets (714) of the training seismic datasets (560) were based on Ricker, Gaussian and the first derivative of the Gaussian wavelets. A ML network (550) after the architecture shown in FIG. 10 was selected and trained, where 500 of the 9000 synthetic datasets were set aside as a validation set. FIGS. 11-17 depict applications and results of the trained ML network (550). It is noted that none of the observed seismic datasets illustrated in the following examples was used in the training of the ML network (550).

FIG. 11 depicts an example of extrapolating a common shot gather (CSG) generated with numerical simulations of acoustic wave propagation. FIG. 11 shows an observed seismic dataset (1102) and an extended seismic dataset (1104) in the form of CSGs. Both the observed seismic dataset (1102) and the extended seismic dataset (1104) are in the time-receiver domain where the time is indicated in seconds by the vertical axis (1106) and the receiver number is indicated by the horizontal axis (1108). The observed seismic dataset (1102) is composed of waveforms with a duration of 6 seconds simulated at 1200 receivers. As seen, the observed seismic dataset (1102) includes events of reflection and refraction. Before performing extrapolation of the observed seismic dataset (1102), 20 receivers of zero amplitude are added to the left of the CSG, and other 20 receivers of zero amplitude are added to the right of the CSG. This is more clearly seen in the panels (1110) and (1112) that show a close-up of the waveforms enclosed by the dashed rectangles (1114) and (1116), respectively. In panel (1110) waveforms at receivers 1-20 have zero amplitude, and in panel (1112) the zero-amplitude waveforms are at receivers 1221-1240. 20 receivers are used to extrapolate the observed seismic dataset (1102) at each edge because the ML network (550) was trained using 20 receivers.

The extended seismic dataset (1104) is obtained after a single application of the ML network (550) to the observed seismic dataset (1102). Panels (1110) and (1112) in FIG. 11 show a close-up of the waveforms enclosed by the dashed rectangles (1122) and (1124), respectively. As seen in panels (1118) and (1120) the reflectivity events have been smoothly extended to the 20 receivers added to the left and right edges, respectively.

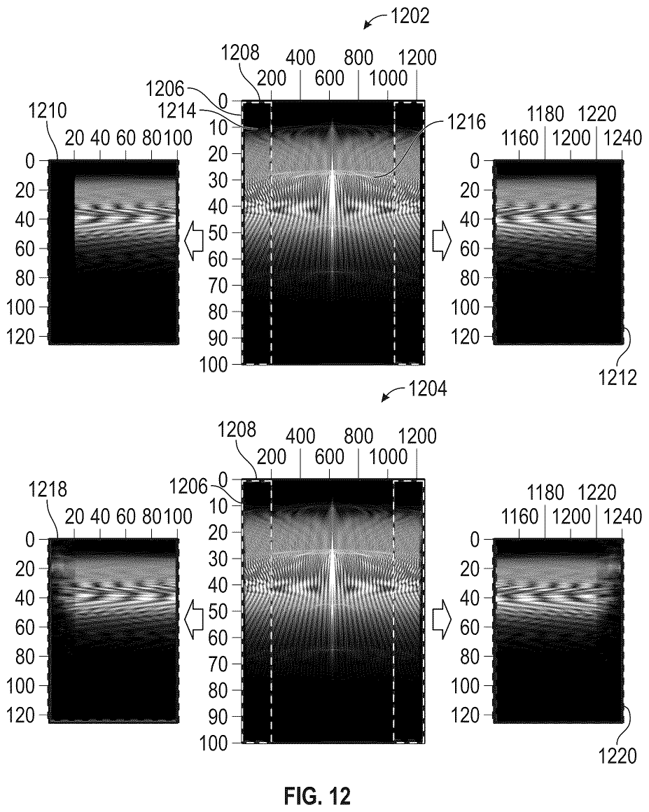

The capabilities of the proposed method of extrapolation are further illustrated in FIG. 12. FIG. 12 shows the observed and extended seismic datasets (1102, 1104) of FIG. 11 transformed to the frequency-receiver domain. Panels (1202) and (1204) are obtained by applying a 1D Fourier transform in time to CSGs (1102) and (1104) respectively. Thus, the vertical axis (1206) of panels (1202) and (1204) indicates frequency, and the horizontal axis (1208) indicates the receiver number. Zones of zero amplitude can be noticed in panels (1210) and (1212) that show a close-up of the lateral edges of CSG (1102) enclosed by the dashed rectangles (1214) and (1216), respectively. The corresponding zones in panels (1218) and (1220) illustrate that the reflectivity events are continuous also in the frequency-receiver domain, even though the extrapolation was performed in the time-receiver domain.

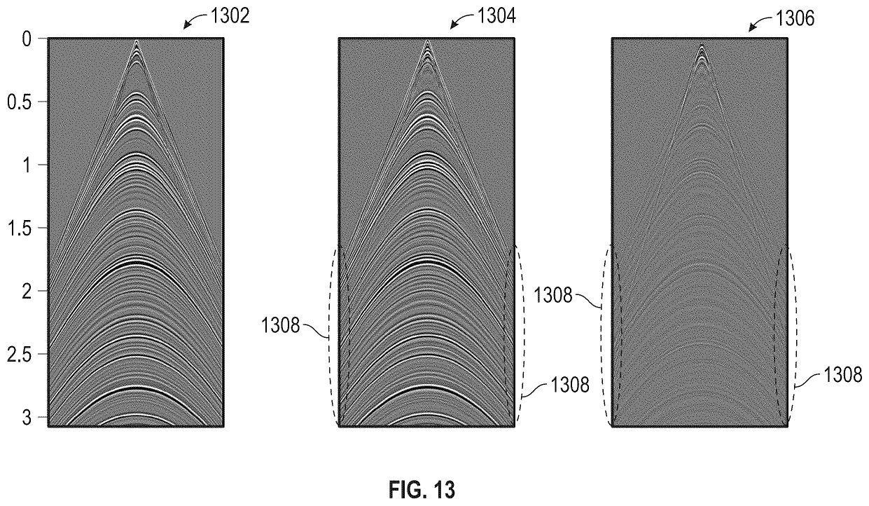

The ML network (550) was also used to process the simulated CSG illustrated in FIG. 4. A pair of CSGs including an observed seismic dataset (1302) and an extended seismic dataset (1304) is shown in FIG. 13. The extended seismic dataset (1304) is further processed to remove multiples with tapering and the R-EPSI algorithm. Panel (1306) shows the difference between the observed seismic dataset (1302) and the extended seismic dataset (1304). When compared with the non-extended CSG (412) of FIG. 4, the artifacts at the edges of the extended seismic dataset (1304) enclosed by the dashed ellipses (1308) are significantly reduced. In panel (1306) the edge effects induced by the R-EPSI algorithm are hardly visible within the dashed ellipses (1308).

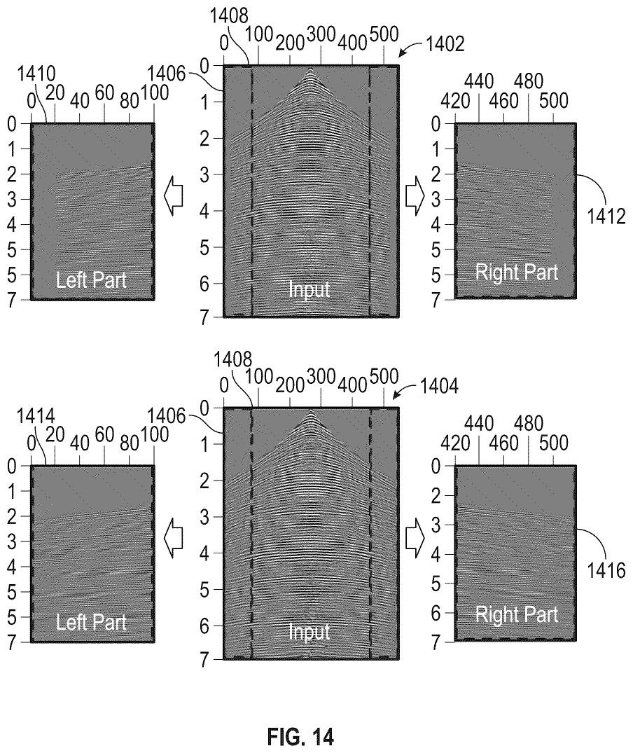

FIG. 14 shows an example of extrapolating a CSG generated with acquired seismic data. Both the observed and the extended datasets (1402, 1404) include reflection and refraction events in the time-receiver domain where time is indicated in the vertical axis (1406) and the receiver number is indicated in the horizontal axis (1408). Panels (1410, 1412) show close-ups of the lateral edges of CSG (1402) including regions of 20 receivers with zero amplitude. Results of extrapolating with the same machine-learning-model used in the previous examples with simulated seismic data are shown in CSG (1404). Panels (1414) and (1416) show the results of extrapolating the events of seismic reflectivity on the left and right edges of CGS (1402). The extended seismic dataset (1404) illustrates the effectiveness of the proposed method to extrapolate with continuity the events of seismic reflectivity in cases including acquired seismic data.

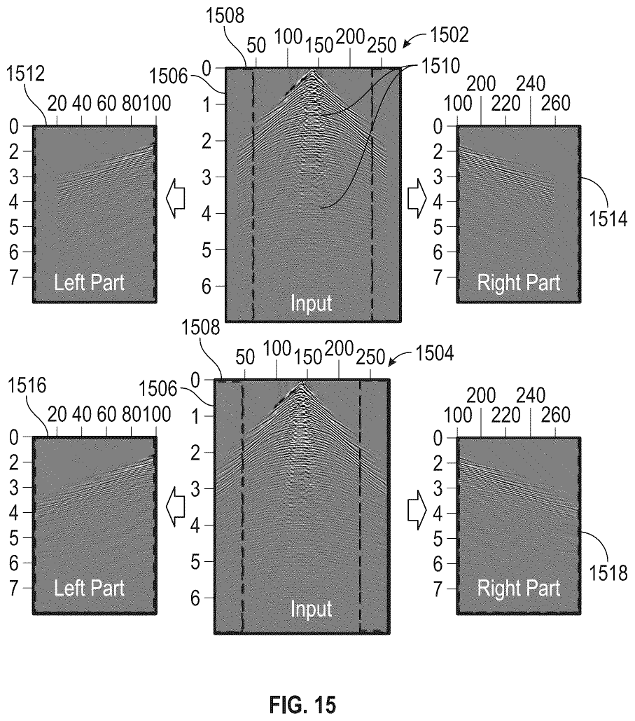

A second example of extrapolating a CSG generated with acquired seismic data is shown in FIG. 15. Again, both the observed and the extended datasets (1502, 1504) are CSGs in the time-receiver domain where time is indicated in the vertical axis (1506) and the receiver number is indicated in the horizontal axis (1508). In this example, the observed seismic dataset (1502) includes events of seismic reflectivity (1510), but with strong variations of amplitudes and frequency content in time and space. The left panel (1512) and the right panel (1514) show close-ups of the corresponding lateral edges of the observed seismic dataset (1502) including the regions of 20 receivers with zero amplitude. The extended seismic dataset (1504) was obtained with the same ML network (550) used in the previous examples. The left panel (1516) and the right panel (1518) show the continuous extrapolation of the events of seismic reflectivity (1510) on the respective left and right edges of the observed seismic dataset (1502). As seen in panels (1516) and (1518), the proposed method is capable to generate data in the regions of 20 receivers with a time-space variation of amplitude and frequency content similar to the acquired data in the observed seismic dataset (1502).

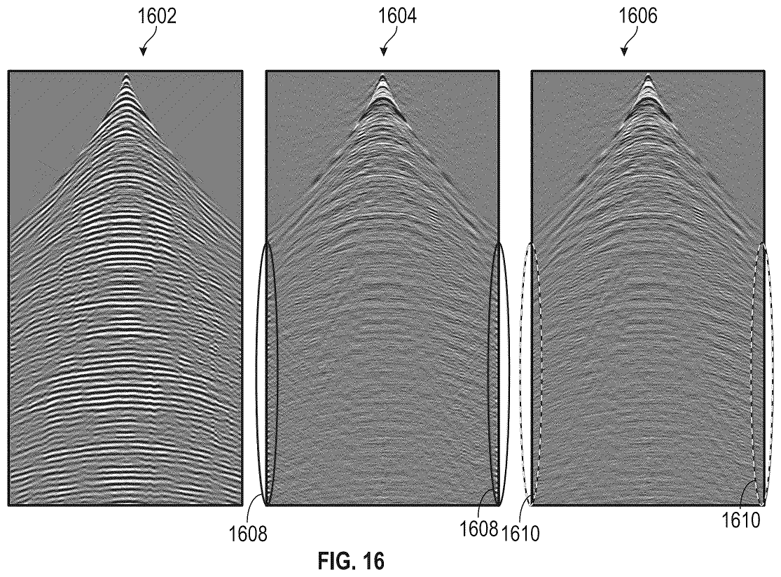

A final example with acquired seismic data is shown in FIG. 16, where a CSG is extended at the lateral edges before filtering for multiple removal. The observed seismic dataset (1602) generated with acquired seismic data includes events of seismic reflectivity in the time-receiver domain. A filtered seismic dataset (1604) illustrates the results of filtering the observed seismic dataset (1602) for multiple removal, without performing extrapolation. The resulting edge effects can be observed at both edges of the filtered seismic dataset (1604) in the continuous ellipses (1608). On the other hand, a filtered extended seismic dataset (1606) shows the results of first extrapolating the observed seismic dataset (1602) with the proposed method and then filtering for multiple removal. The receivers added to extrapolate the observed seismic dataset (1602) have been removed after filtering. As seen in the dashed ellipses (1610), no edge artifacts are visible in the filtered extended seismic dataset (1606).

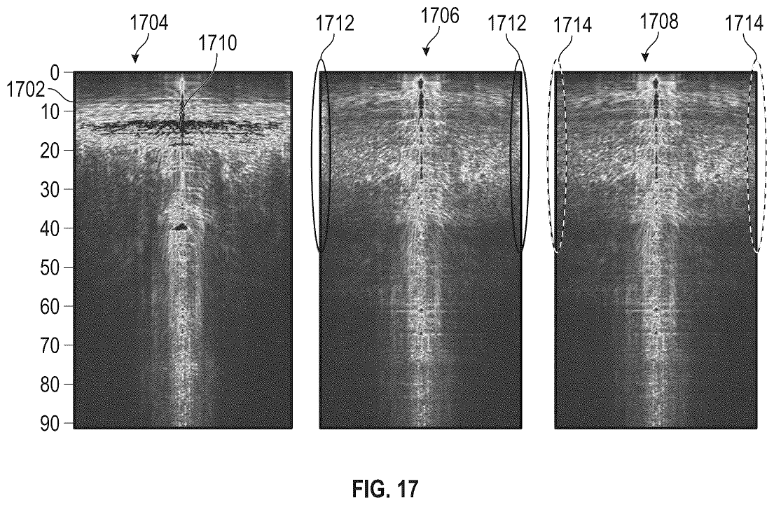

FIG. 17 shows the same data of FIG. 16 but now represented in the frequency-receiver domain, where frequency in Hz is indicated by the vertical axis (1702). Panels (1704, 1706, 1708) are obtained by applying the 1D Fourier transform in time to data in panels (1602, 1604, 1606) respectively. Panel (1704) corresponds to the transformed observed seismic dataset and shows significant energy (1710) at about 15 Hz. Such energy is strongly reduced in the center panel that shows the transformed filtered seismic dataset (1706) resulting from filtering the observed seismic dataset (1602) to remove multiples. The continuous ellipses (1712) show that edge effects due to filtering are visible at the left and right edges of the transformed filtered seismic dataset (1706). The right panel of FIG. 17 shows the transformed filtered extended seismic dataset (1708) obtained from extrapolating the observed seismic dataset (1602) before filtering. The edge artifacts in the transformed filtered extended seismic dataset (1708) are less visible, as indicated by the dashed ellipses (1714).

With the methods disclosed herein, the ML network (550) can be applied to any kind of observed seismic datasets (202) (e.g., pre-stacked or stacked seismic data), in any kind of domain (e.g., common shot, receiver or midpoint domains) and number of dimensions (1D, 2D and higher). The ML network (550) can extrapolate observed seismic datasets (202) beyond the edges of the domain with a low computational cost and minimal user interaction. By training the ML network (550) with training seismic datasets (560) based on simple geometric shapes, expensive physical modelling and related simplifying assumptions may be avoided. In addition, by applying a high number of random perturbations to the generation parameters (716), the resulting training seismic dataset (560) may have a desired level of diversity to efficiently extrapolate observed seismic datasets (202) that were not used during training. The method allows performing mathematical operations on the extended seismic dataset (508) with minimal or no edge effects, and without incurring in loss of information due to tapering operations.

In some embodiments the wellbore planning system (338), the seismic interpretation workstation (340), and the seismic processor (220) may each be implemented within the context of a computer system. FIG. 18 is a block diagram of a computer system (1800) used to provide computational functionalities associated with described algorithms, methods, functions, processes, flows, and procedures as described in the instant disclosure, according to an implementation. The illustrated computer (1800) is intended to encompass any computing device such as a high performance computing (HPC) device, a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer (1800) may include a computer that includes an input device, such as a keypad, keyboard, touch screen, or other device that can accept user information, and an output device that conveys information associated with the operation of the computer (1800), including digital data, visual, or audio information (or a combination of information), or a GUI.

The computer (1800) can serve in a role as a client, network component, a server, a database or other persistency, or any other component (or a combination of roles) of a computer system for performing the subject matter described in the instant disclosure. The illustrated computer (1800) is communicably coupled with a network (1802). In some implementations, one or more components of the computer (1800) may be configured to operate within environments, including cloud-computing-based, local, global, or other environment (or a combination of environments).

At a high level, the computer (1800) is an electronic computing device operable to receive, transmit, process, store, or manage data and information associated with the described subject matter. According to some implementations, the computer (1800) may also include or be communicably coupled with an application server, e-mail server, web server, caching server, streaming data server, business intelligence (BI) server, or other server (or a combination of servers).

The computer (1800) can receive requests over network (1802) from a client application (for example, executing on another computer (1800)) and responding to the received requests by processing the said requests in an appropriate software application. In addition, requests may also be sent to the computer (1800) from internal users (for example, from a command console or by other appropriate access method), external or third-parties, other automated applications, as well as any other appropriate entities, individuals, systems, or computers.

Each of the components of the computer (1800) can communicate using a system bus (1803). In some implementations, any or all of the components of the computer (1800), both hardware or software (or a combination of hardware and software), may interface with each other or the interface (1804) (or a combination of both) over the system bus (1803) using an application programming interface (API) (1807) or a service layer (1808) (or a combination of the API (1807) and service layer (1808). The API (1807) may include specifications for routines, data structures, and object classes. The API (1807) may be either computer-language independent or dependent and refer to a complete interface, a single function, or even a set of APIs. The service layer (1808) provides software services to the computer (1800) or other components (whether or not illustrated) that are communicably coupled to the computer (1800). The functionality of the computer (1800) may be accessible for all service consumers using this service layer (1808). Software services, such as those provided by the service layer (1808), provide reusable, defined business functionalities through a defined interface. For example, the interface may be software written in JAVA, C++, or other suitable language providing data in extensible markup language (XML) format or other suitable format. While illustrated as an integrated component of the computer (1800), alternative implementations may illustrate the API (1807) or the service layer (1808) as stand-alone components in relation to other components of the computer (1800) or other components (whether or not illustrated) that are communicably coupled to the computer (1800). Moreover, any or all parts of the API (1807) or the service layer (1808) may be implemented as child or sub-modules of another software module, enterprise application, or hardware module without departing from the scope of this disclosure.

The computer (1800) includes an interface (1804). Although illustrated as a single interface (1804) in FIG. 18, two or more interfaces (1804) may be used according to particular needs, desires, or particular implementations of the computer (1800). The interface (1804) is used by the computer (1800) for communicating with other systems in a distributed environment that are connected to the network (1802). Generally, the interface (1804) includes logic encoded in software or hardware (or a combination of software and hardware) and operable to communicate with the network (1802). More specifically, the interface (1804) may include software supporting one or more communication protocols associated with communications such that the network (1802) or interface's hardware is operable to communicate physical signals within and outside of the illustrated computer (1800).

The computer (1800) includes at least one computer processor (1805). Although illustrated as a single computer processor (1805) in FIG. 18, two or more processors may be used according to particular needs, desires, or particular implementations of the computer (1800). Generally, the computer processor (1805) executes instructions and manipulates data to perform the operations of the computer (1800) and any algorithms, methods, functions, processes, flows, and procedures as described in the instant disclosure.

The computer (1800) also includes a memory (1809) that holds data for the computer (1800) or other components (or a combination of both) that may be connected to the network (1802). For example, memory (1809) may be a database storing data consistent with this disclosure. Although illustrated as a single memory (1809) in FIG. 18, two or more memories may be used according to particular needs, desires, or particular implementations of the computer (1800) and the described functionality. While memory (1809) is illustrated as an integral component of the computer (1800), in alternative implementations, memory (1809) may be external to the computer (1800).

The application (1806) is an algorithmic software engine providing functionality according to particular needs, desires, or particular implementations of the computer (1800), particularly with respect to functionality described in this disclosure. For example, application (1806) can serve as one or more components, modules, applications, etc. Further, although illustrated as a single application (1806), the application (1806) may be implemented as multiple applications (1806) on the computer (1800). In addition, although illustrated as integral to the computer (1800), in alternative implementations, the application (1806) may be external to the computer (1800).

There may be any number of computers (1800) associated with, or external to, a computer system containing computer (1800), each computer (1800) communicating over network (1802). Further, the term “client,” “user,” and other appropriate terminology may be used interchangeably as appropriate without departing from the scope of this disclosure. Moreover, this disclosure contemplates that many users may use one computer (1800), or that one user may use multiple computers (1800).

In some embodiments, the computer (1800) is implemented as part of a cloud computing system. For example, a cloud computing system may include one or more remote servers along with various other cloud components, such as cloud storage units and edge servers. In particular, a cloud computing system may perform one or more computing operations without direct active management by a user device or local computer system. As such, a cloud computing system may have different functions distributed over multiple locations from a central server, which may be performed using one or more Internet connections. More specifically, cloud computing system may operate according to one or more service models, such as infrastructure as a service (IaaS), platform as a service (PaaS), software as a service (SaaS), mobile “backend” as a service (MBaaS), serverless computing, artificial intelligence (AI) as a service (AIaaS), and/or function as a service (FaaS).

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed is:

1. A method, comprising:
obtaining, using a seismic processor, a training seismic dataset, comprising an input seismic dataset with a first extent and an output seismic dataset with a second extent, wherein the second extent is greater than the first extent; and
training, using the seismic processor and the training seismic dataset, a machine-learning (ML) network to predict the output seismic dataset, at least in part, from the input seismic dataset.

2. The method of claim 1, further comprising:
obtaining an observed seismic dataset pertaining to a subsurface region of interest with a third extent; and
predicting, using the seismic processor and the trained ML network, an extended seismic dataset with a fourth extent, at least in part, from the observed seismic dataset, wherein the fourth extent is greater than the third extent.

3. The method of claim 1, wherein the training seismic dataset comprises a synthetic seismic dataset.

4. The method of claim 3, wherein the synthetic seismic dataset comprises:
a plurality of synthetic events of seismic reflectivity having a geometrical trajectory in space-time; and
at least one seismic wavelet.

5. The method of claim 4, wherein the synthetic seismic dataset further comprises random perturbations to at least one of the at least one seismic wavelet and the geometrical trajectory.

6. The method of claim 1, wherein the ML network is a convolutional neural network.

7. The method of claim 1, wherein training the ML network comprises supervised learning.

8. The method of claim 2, wherein the first extent, the second extent, the third extent, and the fourth extent are each a spatial extent.

9. The method of claim 2, further comprising:
determining, using the seismic processor, a seismic image of the subsurface region of interest based, at least in part, on the extended seismic dataset; and
determining, using a seismic interpretation workstation, a drilling target in the subsurface region of interest based, at least in part, on the seismic image.

10. The method of claim 9, further comprising:
planning, using a wellbore planning system, a planned wellbore trajectory to intersect the drilling target; and
drilling, using a drilling system, a wellbore guided by the planned wellbore trajectory.

11. A non-transitory computer-readable medium storing computer-executable instructions stored thereon that, when executed by a computer processor, cause the computer processor to perform steps of:
obtaining a training seismic dataset, comprising an input seismic dataset with a first extent and an output seismic dataset with a second extent, wherein the second extent is greater than the first extent; and
training, using the training seismic dataset, a machine-learning (ML) network to predict the output seismic dataset, at least in part, from the input seismic dataset.

12. The non-transitory computer-readable medium of claim 11, the steps further comprising:
receiving an observed seismic dataset pertaining to a subsurface region of interest with a third extent; and
predicting, using the trained ML network, an extended seismic dataset with a fourth extent, at least in part, from the observed seismic dataset, wherein the fourth extent is greater than the third extent.

13. The non-transitory computer-readable medium of claim 11, wherein the training seismic dataset comprises a synthetic seismic dataset.

14. The non-transitory computer-readable medium of claim 13, wherein the synthetic seismic dataset comprises:
a plurality of synthetic events of seismic reflectivity having a geometrical trajectory in space-time; and
at least one seismic wavelet.

15. The non-transitory computer-readable medium of claim 11, wherein the ML network is a convolutional neural network.

16. A system, comprising:
a seismic acquisition system configured to record an observed seismic dataset pertaining to a subsurface region of interest; and
a seismic processor, configured to:
obtain a training seismic dataset, comprising an input seismic dataset with a first extent and an output seismic dataset with a second extent, wherein the second extent is greater than the first extent;
train, using the training seismic dataset, a machine-learning (ML) network to predict the output seismic dataset, at least in part, from the input seismic dataset;
obtain an observed seismic dataset pertaining to a subsurface region of interest with a third extent; and
predict, using the trained ML network, an extended seismic dataset with a fourth extent, at least in part, from the observed seismic dataset, wherein the fourth extent is greater than the third extent.

17. The system of claim 16, wherein the training seismic dataset comprises a synthetic seismic dataset.

18. The system of claim 16, wherein the ML network is a convolutional neural network.

19. The system of claim 16, further comprising:
a seismic processor, configured to determine a seismic image of the subsurface region of interest based, at least in part, on the extended seismic dataset; and
a seismic interpretation workstation, configured to determine a drilling target in the subsurface region of interest based, at least in part, on the seismic image.

20. The system of claim 19, further comprising:
a wellbore planning system, configured to plan a planned wellbore trajectory to intersect the drilling target; and
a drilling system configure to drill a wellbore guided by the planned wellbore trajectory.
